(19) United States
(12) Patent Application Publication
(10) Pub. No.: US 2007/0285500 A1
(43) Pub. Date: Dec. 13, 2007

(54) Method and Apparatus for Video Mixing

(75) Inventors: Zhonghua Ma, North Epping (AU); Jianwei Wang, Larkspur, CA (US); Marwan A. Jabri, Tiburon, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dilithium Holdings, Inc., Petaluma, CA (US)

(21) Appl. No.: 11/738,806

(22) Filed: Apr. 23, 2007

Related U.S. Application Data
(60) Provisional application No. 60/793,746, filed on Apr. 21, 2006.

(51) Int. Cl. H04N 7/14

(52) U.S. Cl. 348/14.07; 348/E07.077

(57) ABSTRACT

An apparatus for use in video mixing of multiple video sources compressed in one or more video codecs includes a bitstream unpacker configured to receive and unpack each of the multiple video sources to provide intermediate video parameters including transform-domain coefficients, frame header information, macroblock header information, and motion vector data. The apparatus also includes an intermediate coefficient buffer coupled to the bitstream unpacker and a decision module coupled to the bitstream unpacker. The apparatus further includes a transform-domain coefficient downscaling module coupled to the intermediate coefficient buffer, a motion vector refinement module coupled to the bitstream unpacker, and a bitstream packer coupled to the decision module, the transform-domain coefficient downscaling module, and the motion vector refinement module. The bitstream packer is configured to output multiple video output streams in an output frame and the multiple output streams are compressed using the one or more video codecs.

### CROSS-REFERENCES TO RELATED APPLICATIONS

The present application claims priority to U.S. Provisional Patent Application No. 60/793,746, filed on Apr. 21, 2006, which is commonly owned and hereby incorporated by reference in its entirety for all purposes.

### FIELD OF THE INVENTION

The present invention relates generally to digital video signal processing. More particularly, the invention provides a method and an apparatus for the mixing of compressed video streams from multiple devices into a mixed stream sent back to each device in the same video size and format as the input. Merely by way of example, the invention has been applied to the mixing of compressed video streams from multiple conferees in a conferencing gateway, but it would be recognized that the invention may also include other applications.

### BACKGROUND OF THE INVENTION

With the great success of several international video standards, such as H.261, H.263, MPEG4, and H.264/AVC, video communication and video conferencing has become more and more popular. In a multiple client video conferencing application, a number of clients are usually connected to a Multipoint Control Unit (MCU) or a Multimedia Communication Gateway (MCG), so that each attendee can see and communicate with any of the other participants in the same conference.

When attending a multiple client video conference it is desirable to display all, or some subset of, the other participants on the terminal screen of each attendee. This implies that each client desires a mixed bitstream with an output-specific mixed content display. The layout may consist of a number of segments, where each segment is associated with the video sent by a certain participant. Moreover, such an association between the display segment and the participant may vary for each attendee and may be changed dynamically during the conference.

Conventional multi-point video communication solution requires heavy and expensive computation resources. Generally, the MCU or MCG decodes each input compressed video stream into uncompressed video data and then composites one or more of the uncompressed video data into mixed video data according to the associated display layout for each attendee, encodes the mixed video sequence according to the compressed stream format of each attendee, and outputs the mixed compressed bitstream back to each attendee or client.

In some conventional video conferencing applications, a downscaling process is used in addition to full decoding, mixing, and full encoding processes to produce a mixed video which has the same resolution as those inputs. The downscaling and mixing processes are generally performed in the spatial domain. Such conventional methods are computationally expensive due to the full motion estimation process used to encode the mixed output video stream.

FIG. 1 illustrates a conventional video mixing application in a multipoint video communication system where four participants attend a video conference from different devices. The MCU located in the network receives four compressed video streams from each of the conferencing participants, applies video mixing to the input video, and outputs mixed video streams back to each of the conference participants. It is noted that the input video streams from all the participants usually have a same resolution size but the mixed stream sent back to each participant may or may not have the same resolution as that of the input video streams.

FIG. 2 illustrates a conventional work flow of a video mixing method. 201a-d represent four raw video frames from four input video streams of a video conference. All the input streams are fully decompressed by video decoders to raw video, such as YUV or RGB, before mixing. All of the inputs have a same video resolution and usually are compressed using a same video codec standard, such as MPEG2, MPEG4, H.263, or H.264 AVC. The frames from four input streams are then mixed in the pixel domain at particular temporal coordinates to form a new mixed frame 202, which has a resolution equal to the sum of all four input frames, i.e., the mixed frame has a CIF resolution if all input streams have QCIF resolutions. The mixed video frame 202 is further downscaled, for example by a bilinear filter, in 203 to match the resolution of the input video frames (i.e., QCIF). Finally the downscaled mixed frame is re-encoded by a video encoder to generate a mixed video stream which is sent back to each conference participants accordingly.

FIG. 3 illustrates a block diagram of a conventional video mixing system. In this example all input and output compressed video streams are encoded by the H.263 video codec. Each input compressed video stream is decompressed by sending it to an H.263 decoder. The H.263 decoder consists of functional units such as variable length decoding (VLD), inverse quantization (Q₁⁻¹), inverse DCT transform (IDCT), motion compensation (MC), and a pixel frame buffer. The uncompressed video data can be stored in a video frame separately for each decoded input. The individual video frames can then be mixed in the pixel domain and downscaled by a bilinear filter on a per frame basis to match the output video resolution. Finally, the mixed frame is encoded by a H.263 encoder to generate several compressed video outputs which are sent back to conference participants. The H.263 encoder usually includes functional units such as full-scale motion estimation (ME), discrete cosine transform (DCT), quantization (Q₂), variable length coding (VLC). It also includes inverse quantization (Q₂⁻¹), inverse DCT (IDCT), MC and frame buffer for the reconstruction of reference frame saved in the frame buffer.

Since the processes of frame-based frame downscaling and full re-encoding are very computationally intensive, particularly with full-scale motion estimation (ME) and an exhaustive MB mode selection (i.e., intra and inter) in H.263 encoding, such video mixing approaches usually represent a solution with very low computational efficiency. Therefore, there is a need in the art for a video mixing solution characterized by a low computation cost and reduced resource demands.

### SUMMARY OF THE INVENTION

The present invention relates to methods and systems for mixing a plurality of compressed input video streams into one or more compressed video output streams for multipoint video conferencing applications. Embodiments of the present invention maintain flexibility with respect to input/output compression formats and resolution while providing low computation costs.

According to an embodiment of the present invention, methods and apparatus for video mixing of video bitstreams from multiple mobile clients in a conferencing gateway are provided. The apparatus is able to receive multiple video streams encoded with a same frame size (i.e., QCIF, CIF, and the like) but by different video standards, such as H.263, H.264, MPEG4, or the like. The apparatus is able to output a mixed video stream back to each client with a frame size and video format the same as the input stream. The input video streams are unpacked to a parameter domain where mixing and downscaling are performed and the mixed streams are packed according to the video format of each client. Thus, embodiments of the present invention provide for the combination of three or more modules, including a mixed macro-block (MB) coding mode decision module, a selective coefficient mixing and downscaling module, and an adaptive motion vector (MV) re-sampling and refinement module. Embodiments of the present invention provide a substantial savings in computational costs, a marginal savings on the bit-rate, and a mixed video bitstream with little to no video quality loss.

According to an embodiment of the present invention, an apparatus for use in video mixing of multiple video sources compressed in one or more video codecs is provided. The apparatus includes a bitstream unpacker configured to receive and unpack each of the multiple video sources to provide intermediate video parameters including transform-domain coefficients, frame header information, macroblock header information, and motion vector data. The apparatus also includes an intermediate coefficient buffer coupled to the bitstream unpacker and configured to store the transform-domain coefficients. The apparatus further includes a decision module coupled to the bitstream unpacker and configured to provide an output macroblock mode based, in part, on the intermediate video parameters. Moreover, the apparatus includes a transform-domain coefficient downscaling module coupled to the intermediate coefficient buffer and configured to generate transform-domain output coefficients. Additionally, the apparatus includes a motion vector refinement module coupled to the bitstream unpacker and configured to generate an output motion vector. The apparatus also includes a bitstream packer coupled to the decision module, the transform-domain coefficient downscaling module, and the motion vector refinement module. The bitstream packer is configured to output multiple video output streams in an output frame and the multiple output streams are compressed using the one or more video codecs.

According to another embodiment of the present invention, a method of mixing video bitstreams from a plurality of sources coupled through a communication system is provided. The method includes receiving a first video stream from a first source and receiving a second video stream from a second source. The method also includes unpacking the first video stream to provide a first set of macroblock coding modes, first motion vector data, and first transform coefficients and unpacking the second video stream to provide a second set of macroblock coding modes, second motion vector data, and second transform coefficients. The method further includes predicting an encoding mode for a first output macroblock based, in part, on the first set of macroblock coding modes, downscaling the first transform coefficients to provide first output transform coefficients, and constructing the first output macroblock using the first output transform coefficients. Additionally, the method includes downscaling the second transform coefficients to provide second output transform coefficients and constructing the second output macroblock using the second output transform coefficients. Moreover, the method includes constructing an output video stream having an output video frame including the first output macroblock disposed in a first portion of the output video frame and the second output macroblock disposed in a second portion of the output video frame.

Embodiments of the present invention provide numerous benefits in comparison with convention techniques. For example, an embodiment performs video mixing while avoiding full decoding and full encoding by mixing in a video parameter domain. Another embodiment reuses pre-encoded video data from input video streams and selectively activates mixing and downscaling processes. Compared with conventional full decoding, full mixing in picture spatial domain, full scaling in spatial domain and full decoding approaches, embodiments of the present invention reduce computation costs, particular costs associated with motion estimation processes used during full encoding.

Additional benefits provided herein include achieving better video quality of the output mixed video stream by predicting the motion data for the mixed output macroblocks in the compressed video parameter domain. Further benefits include reduction of latency by producing a mixed output in a macro-block based manner before an entire associated input video frame is received. Thus, embodiments of the present invention reduce both algorithm delay and processing delay.

Yet further benefits of the present invention include reduced memory usage by performing video mixing in a macro-block based manner, thus utilizing adjoining macroblocks information, which constitutes only a small portion of a frame. Some embodiments utilize advanced rate control mechanisms using pre-encoded compression parameter and motion information from input video streams, thereby reducing the bandwidth fluctuations or the bandwidth of the mixed video bitstream.

The objects, features, and advantages of the present invention, which are believed to be novel, are set forth with particularity in the appended claims. The present invention, both as to its organization and manner of operation, together with further objects and advantages, may best be understood by reference to the following description, taken in connection with the accompanying drawings.

### BRIEF DESCRIPTION OF THE DRAWINGS

For a complete understanding of the present invention, reference to the detailed description and appended claims should be considered along with the following illustrative figures, wherein the use of a same reference numbers refer to similar, or same, elements throughout the figures. The illustrative figures being:

FIG. 1 illustrates a conventional video mixing application in a multipoint video communication system;

FIG. 2 illustrates a workflow of a conventional video mixing method;

FIG. 3 illustrates a block diagram of a conventional video mixing system;

FIG. 4 illustrates a conferencing system according an embodiment of the present invention;

FIG. 5 illustrates an apparatus of a video mixing system according to an embodiment of the present invention;

FIG. 6 illustrates an apparatus for a mixed macroblock coding mode decision in a video mixing system according to an embodiment of the present invention;

FIG. 7 illustrates an apparatus for adaptive mixed motion vector re-sampling and refinement in a video mixing system according to an embodiment of the present invention;

FIG. 8 illustrates an apparatus for selective coefficient mixing and downscaling in a video mixing system according to an embodiment of the present invention;

FIG. 9 illustrates an apparatus for video bitstream unpacking in a video mixing system according to an embodiment of the present invention;

FIG. 10 illustrates an apparatus for video bitstream packing in a video mixing system according to an embodiment of the present invention;

FIG. 11 illustrates mapping and downscaling four macroblocks from an input frame into one macroblock in an output frame according to an embodiment of the present invention;

FIG. 12 illustrates an exemplary display layout for a mixed QCIF frame with four inputs according to an embodiment of the present invention;

FIG. 13 is a flowchart illustrating a mixed macroblock coding mode decision method according to an embodiment of the present invention;

FIG. 14 is a flowchart illustrating a selective coefficient mixing/downscaling method according to an embodiment of the present invention;

FIG. 15, 16, and 17 are flowcharts illustrating mixed motion vector re-sampling and refinement method according to embodiments of the present invention;

FIG. 18 illustrates an exemplary motion refinement for an integer motion vector according to an embodiment of the present invention; and

FIG. 19 illustrates an exemplary motion refinement for an half-pixel motion vector according to an embodiment of the present invention.

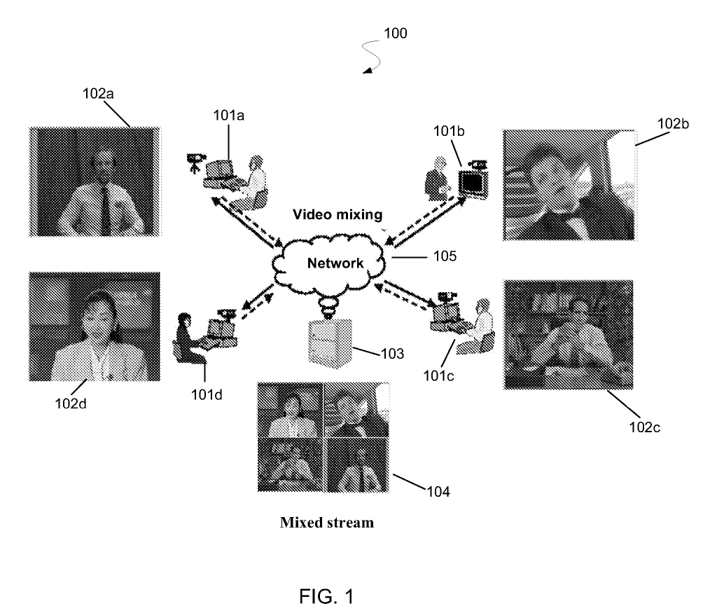

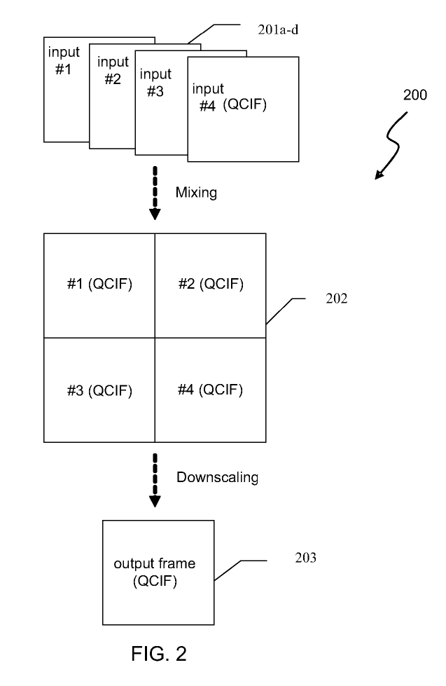

### DETAILED DESCRIPTION OF SPECIFIC EMBODIMENTS

A method and an apparatus of the present invention are discussed in detail below. In the following description, for purposes of explanation, numerous specific details are set forth in order to provide a thorough understanding of the present invention. A person skilled in the art will recognize that other steps and applications than those listed here as examples are possible without departing from the spirit of the present invention.

An exemplary embodiment of the present invention processes multiple video stream inputs and manages video conferencing for up to five attendees. The attendees use multimedia (audio, video and data) terminals, such as PDAs or smart phones such as 3G-324M video telephones, to send and receive compressed video streams. It is likely that all the input streams for conference attendees are in the same video resolution or frame size (i.e. QCIF or CIF). However they may be encoded by different video standards, such as H.263, H.264/AVC or MPEG4. The invention is not limited to a same resolution or same frame size. The mixed streams output back to each client are in the same frame size, such as QCIF or CIF, as that of the input video stream, and with a compression format same as the input video stream from that client. This allows the devices to operate in a symmetric fashion with regard to the features of the video bitstream, which is preferable in many cases but is not a requirement or limitation of the present invention. This is of particular relevance for video telephones, which are often designed with symmetric properties for their primary purpose for peer to peer videotelephony, and aspects of the present invention allow for them to be involved in conferences with no additional capabilities.

A particular embodiment of the present invention employs a video mixing unit. For each of the input video streams, the video mixing unit is operative according to an output specific conferencing display layout, which may contain the rest of the users in one screen. Three specific modules are used to generate output data from unpacked data for the video stream transmitted back to the current user. These three modules, which include a mixed macro-block (MB) coding mode decision module, a selective coefficient mixing and downscaling module, and an adaptive motion vector (MV) re-sampling and refinement module, are features of the present invention for generating mixed video streams from multi-input video streams with a reduced computation cost.

The mixed-MB coding mode decision module is designed to utilize the unpacked input MB information to reduce computation costs. The module is designed to reuse the input information, such as macroblock headers and picture headers, to predict the encoding mode for the mixed MB without involving a significant amount of computation as a full encoder usually would need to do. The computation reduction is achieved by downscaling the texture of input MBs with certain types of encoding modes and updating the downscaled video data in the mixed frame for mixed video stream generation. Here, texture is used to refer to image information in the spatial domain. Thus, representative parameters could include a DCT coefficient block or the like. This use of the term texture is not intended to limit embodiments of the present invention but merely to provide a description of exemplary embodiments.

The term “encoding mode” refers to intra mode, inter-skipped mode, and inter mode that usually is carried by side information, also called meta information, extracted from input video streams, but it is not limited thereto. The module also takes into account the layout of each downscaled input video streams in the mixed output. A mechanism is used to decide the encoding mode for those MBs located on the boundaries of different downscaled input video in the mixed picture.

The selective coefficient mixing and downscaling module is designed to generate mixed texture for the output MB according to unpacked data of input video streams. The module takes DCT coefficients which are in one MB and are extracted from the input video stream as its main input, mixes the DCT coefficients together according to the encoding mode of each input MB, and downscales the DCT coefficients for the encoding of the mixed MB for output. A global buffer may be allocated to store the mixed and downscaled coefficients and to enable the selective process of mixed and downscaled texture for all the output video frames. The updating of the global buffer is conducted on a 8×8-pel block basis rather than a MB basis (which covers an area of 16×16-pel), and happens only if the side information of encoding parameters of an input MB satisfy certain criteria, which usually relate to the encoding information of the input MB, such as encoding mode and the motion data such as motion vectors and motion residues, but may also include the position of output MB in the mixed picture, and other special condition as well.

The adaptive MV re-sampling and refinement module is designed to provide a computation-efficient motion vector mapping for the output mixed video stream. The module predicts the output motion vector according to the motion data of the four input MBs from which the output MB is downscaled and mixed, and may also take into account of the motion data from MBs in the neighborhood of the output MB, such as adjacent MBs. Herein the term “motion data” mainly refers to the prediction mode, motion vectors, and motion residues, but may include other meanings. Such a process is described as “motion vector re-sampling” throughout the present specification. The adaptive motion vector refinement is capable of adapting its motion search range according to the distribution of the motion vectors which are generated by the MV re-sampling process. The distribution here means the distribution range of the motion vectors in horizontal and vertical directions respectively. The adaptive MV re-sampling and refinement module also embodies fast integer and half-pixel searching algorithms to reduce the computation load without degrading the output video quality.

A further embodiment of the present invention is a video mixing system that can handle a video fast update request very efficiently. As the fast update request arrives, the system can present the next scaled frame as an intra frame (through the means of preset the mixed frame type as intra, and all the encoding mode of the mixed MB as intra. In such case, the motion data from the input streams are skipped, and the DCT coefficients for the output intra mixed MB is directly downscaled in the DCT-domain from the DCT frame buffers. This would also be applicable to any time an intra coded frame would want to be produced, such as the addition of an attendee mid conference.

A further embodiment of the present invention handles different frame rates, or differing frame arrival rates for the video inputs. One efficient approach to handle different frame rate of multiple inputs is to keep the output mixed frame rate the same as the highest frame rate among all the input frame rates. Firstly, the video data from each input stream is unwrapped independently. At the time of encoding a new mixed frame, the data associated with each input are sampled from the latest DCT frame buffer. If the data corresponding to a particular input has not been updated since the latest encoding time (i.e., for a lower input frame rate), all the mixed MB generated using this input data will be encoded in SKIP mode. As a result, the mixed video will always update according to the highest frame rate.

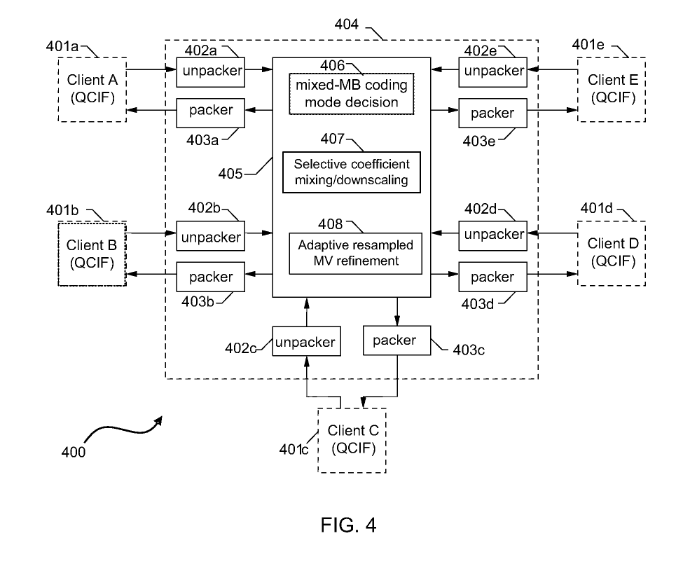

FIG. 4 illustrates a block diagram of a video mixing system according to an embodiment of the present invention. H.263 video streams with resolutions of QCIF are used for illustrative purposes, however the method described here is generic and applies to the video mixing of any video codec standards and resolutions as well as mixtures between different devices supporting different preferences and abilities. The system 404 includes five major modules, namely being video stream unpackers 402a-e, a mixed macroblock (mixed-MB) coding mode decision module 406, a selective coefficient mixing/downscaling module 407, an adaptive motion vector (MV) re-sampling and refinement module 408, and a group of video stream packers 403a-e. The system 404 receives input compressed video streams from each client, or terminal/device, 401a-e and converts them to a group of video data in a parameter domain. The resolution of the compressed video streams from each client could be QCIF, a typical video resolution for mobile terminals. The data from the unpackers 402a-e may include MB header data, motion vectors, and DCT coefficient blocks, but is not limited thereto. The unpacked data, in a parameter domain, are fed into a video mixing block which consists of mixed-MB coding mode decision module 406, selective coefficient mixing and downscaling module 407 and adaptive MV re-sampling and refinement module 408.

The mixed-MB coding mode decision module 406 outputs the coding mode to be used for the output mixed macroblock (mixed MB). The input of the module 406 is the coding mode of input macroblocks (input MBs) which are associated with the mixed MB, and the spatial location of the mixed MB in the mixed frame. The module 406 determines the coding mode of output mixed-MB using a switch-based decision mechanism.

The MV re-sampling and refinement module 408 produces the mixed-MV by two steps: (a) it adaptively re-samples input-MV and mixed MV in a recursive manner, and (b) it refines the mixed-MV in an adaptive range which is based on the distribution of the re-sampled MV values.

The coefficient mixing/downscaling module 407 works in a selective processing manner. It mixes and downscales 8×8 block-based coefficients in the transform domain to the mixed coefficients in the pixel domain by fast DCT downscaling algorithms when the input MB mode or mixed-MB mode meets certain conditions.

These three modules in the block diagram shown for video mixing are designed to save the significant computation cost involved in the decision of mixed-MB coding mode and the motion estimation process, without compromising the bitrate and video quality of the mixed video bitstreams.

The output of the video mixer sends the mixed-frame data in the parameter domain to each packer 403a-e in which a compressed video stream is generated. The generated compressed video stream is sent to each client 401a-e according to the video resolution and format of each client, which could be QCIF and H.263 respectively, and is typically symmetric to the transmission characteristics from the client, especially in a video conference involving mobile devices, such as 3G-324M terminals.

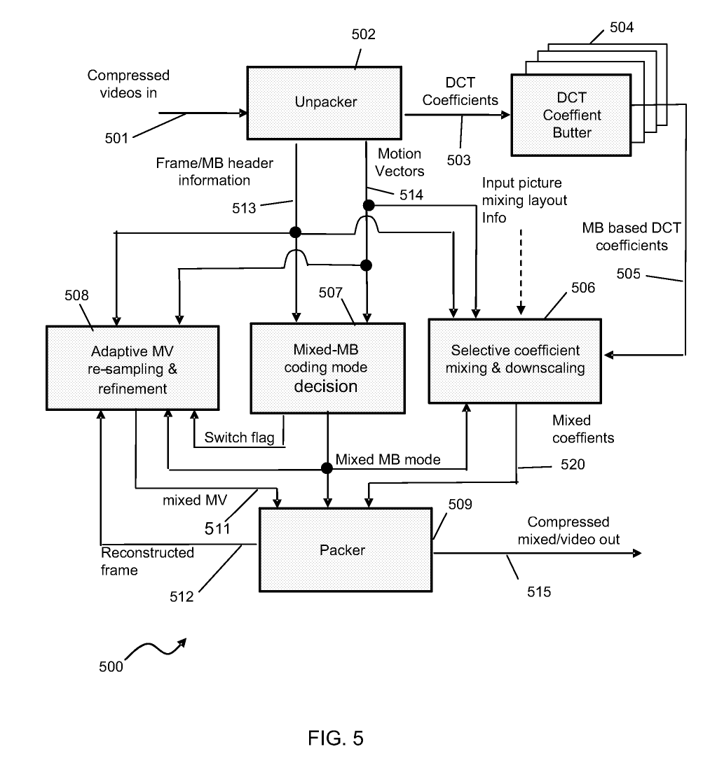

FIG. 5 illustrates a preferred embodiment of the video mixing system in accordance with the present invention. An input compressed video bitstream from a conference attendee is input into an unpacker 502, where frame/MB header data, motion vector data, and DCT coefficients are extracted from the input bitstream.

The unpacked frame/MB header data and motion vectors are then input into the mixed-MB coding mode decision module 507 to determine the mixed MB mode and a switch flag. The switch flag is used to control the adaptive MV re-sampling and refinement module 508 to generate the motion vector associated with the mixed MB where the motion vector is called mixed MV. If the switch flag is set, the processing of MV-re-sampling and refinement is needed. Otherwise, the process can be skipped.

Then, according to the value of the switch flag, the adaptive MV re-sampling and refinement module 508 takes the frame and MB header data and motion vectors from the unpacker 502, predicts the downscaled mixed MV. The predicted mixed-MV is further refined based on the reconstructed frame according to the input MB mode and MV data from the unpacker 502, and the mixed-MB mode from mixed-MB coding mode decision module 507.

The DCT coefficients unpacked from the unpacker 502 can be stored in a set of DCT coefficient buffers 504 according to their MB location in a frame. The output of a DCT coefficient buffer can be MB based DCT coefficients and is sent into the selective coefficient mixing and downscaling module 506.

The selective coefficient mixing and downscaling module 506 processes the MB based DCT coefficients in pixel domain by a selective updating way according to the input MB mode and MV values from the unpacker 502 and the mixed-MB mode from the decision module 507. The process of MB based DCT coefficient in pixel domain is to downscale 8×8 blocks of DCT coefficients into 4×4 blocks of pixel value by IDCT. Only the top-left 4×4 sub-block of each DCT block uses fast 4×4 2D-IDCT. The downscaling is activated only when the corresponding MB is in non-SKIP inter coding mode. The module 506 maps the processed MB based DCT coefficients to mixed coefficients in the pixel-domain, and outputs the mixed coefficients to a packer 509.

Finally all output data from 506, 507 and 508 which include the mixed-MB mode, the mixed MV value, and mixed coefficients, are sent into the packer 509 to generate a compressed mixed video stream in the required format. The packer 509 also reconstructs the mixed video frame to facilitate the adaptive MV refinement process in 508.

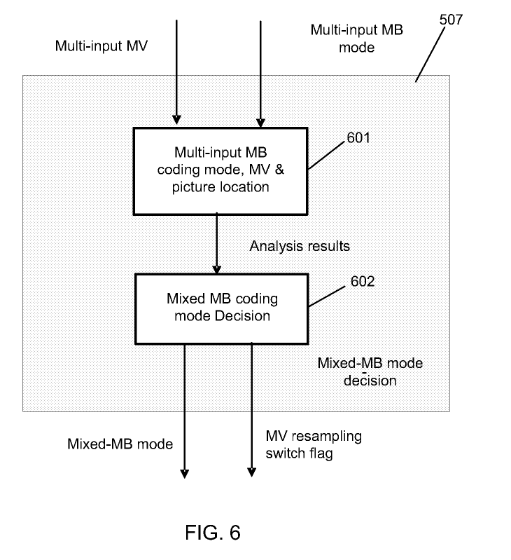

FIG. 6 details a preferred embodiment of the mixed-MB coding mode decision (MBMD) module 507 in the video mixing system according to the present invention.

The architecture of the module 507 can be further broken down into two parts:

1) an analysis part 601 which analyzes the coding modes of input macroblocks (input MB coding mode) from multiple input video streams, the input motion vectors (input MVs) associated with the input macroblocks from the multiple input video streams, and the location of the mixed MB in the mixed frame.

2) a coding mode decision part 602 which formulates the mixed-MB mode and the switch flag according to the analysis results.

The inputs of the module 507 include multi-input MB coding mode, multi-input MV data, and the location information of the mixed-MB in the mixed frame. The term multi-input MV is used to illustrate that multiple input MVs are utilized by embodiments of the present invention. The input data are sent to a first part 601 called the multi-input MB coding mode, MV and picture location analysis part and are analyzed. The analysis result is forwarded to a second part 602 called the mixed MB coding mode decision part to determine an encoding mode for the downscaled mixed-MB using that information. The outputs of 602 include the mixed-MB mode and a flag to switch on the mixed-MV re-sampling process.

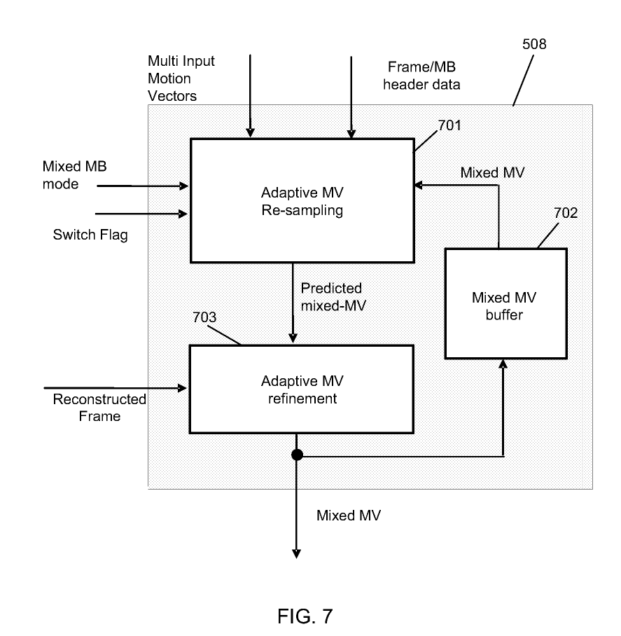

FIG. 7 details a preferred embodiment of the adaptive MV re-sampling and refinement module 508 according to the present invention. The module, referred to as an AMVRR (adaptive MV re-sampling and refinement), takes the multi-input frame and MB header data, input motion vectors, the mixed-MB modes in the neighborhood of the current mixed-MB position, the switch flag from SMBMD module 507, and the reconstructed frame, i.e. the mixed frame, from the bitstream packer module. The AMVRR module may consist of three main parts:

1) A mixed-MV buffer 702 which stores the mixed-MV data generated by the AMVRR module 508 for the current mixed frame;

2) An adaptive MV re-sampling part 701 that has inputs including the frame and MB header data and multi-input MV from 502, mixed MB mode from 507, mixed MV in the neighborhoods of current mixed MB from 702, and switch flag from 507. The output of 701 is predicted mixed MV for the current mixed-MB. The adaptive MV re-sampling part is activated by the switch flag from the SMBMD module, and adaptively predicts the mixed-MV according to the multi-input frame and MB header data, multi-input MV, and mixed-MV in the neighborhoods of current mixed MB;

3) An adaptive MV refinement part 703 which has inputs including the predicted mixed MV from 701 and the reconstructed frame data from 509. The output of this part is an optimal mixed motion vector (optimal MV) which is refined around the predicted mixed MV by minimizing the coefficients difference between the current mixed MB and a corresponding mixed MB in a reference frame reconstructed by 509. In some cases, more than one reference frame might be present and involved in the refinement. The adaptive MV refinement part searches around the predicted mixed MV in an adaptive range according to the distribution of all the re-sampled MV values.

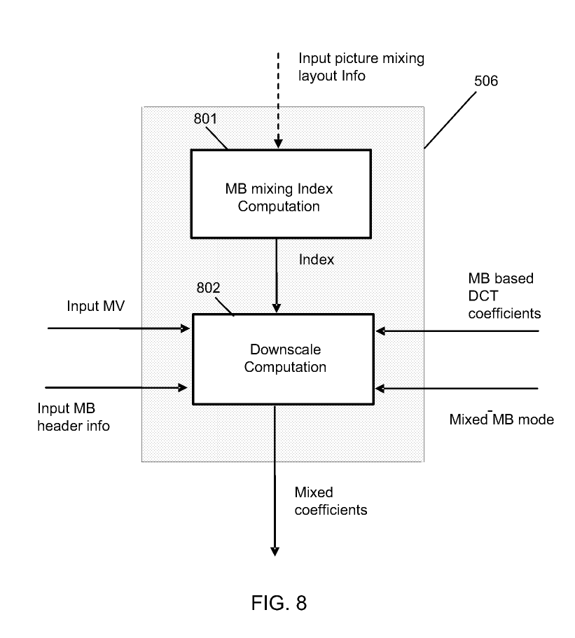

FIG. 8 details a preferred embodiment of the selective coefficient mixing and downscaling module 506 according to the present invention. This module, referred to as SCMD (selective coefficient mixing and downscaling), can be further broken into two main parts:

1) A MB mixing index computation part 801 which determines the index of the multi-input MB used to construct the current mixed-MB; and

2) A downscale computation part 802 which conducts a fast downscaling algorithm on the multi-input DCT coefficients according to the input/mixed MB/MV conditions, and outputs mixed coefficients for the current mixed-MB.

The mixed coefficients for the current mixed-MB could be output in different formats depending on motion the vectors associated with the input MBs. If all motion vectors associated with the input MBs, which are mapped to a MB in the mixed and downscaled output frame, are equal, (which we call “aligned motion”), the motion residues of all the input MB could be downscaled directly in the DCT domain using fast DCT-to-DCT downscaling algorithm to convert motion residues for the mixed MB in the mixed and downscaled frame. If the motion vectors associated with the input MBs are non-aligned, the DCT coefficients could be downscaled using DCT-to-spatial fast algorithm to form scaled raw video data which are input to the video packer for motion compensated video encoding.

The input of the module 801 could be a predetermined picture mixing layout information, i.e. such as the location of a sub-region that the current input video stream will be directed to in the scaled mixed output frame. The output of 801 could be an index which points to the current mixed-MB position in the scaled mixed-frame. The inputs of the module 802 include the input MB header info and input MV from the unpacker module 502, the index of current mixed-MB position from the MB mixing index computation part 801, the MB based DCT coefficients from the DCT coefficient buffer 504, and the MV re-sampling switch flag and mixed MB mode from a mixed-MB coding mode decision module 507. The output of the module is the output of the downscale computation part 802, and is the mixed coefficients, which usually refers to the pixel coefficients of the mixed-MB, but may also include the motion residue or DCT coefficient in certain conditions.

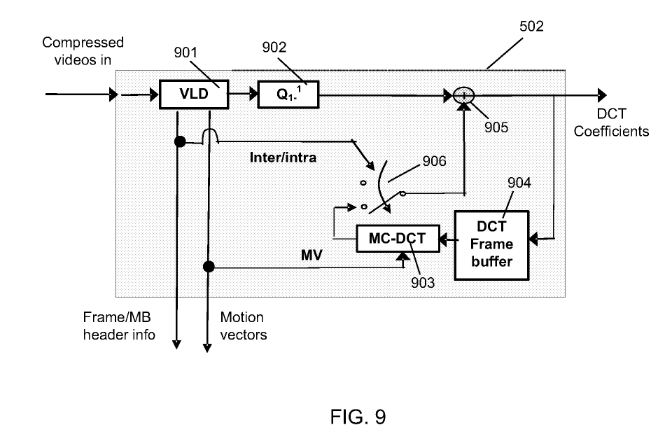

FIG. 9 shows an exemplary block diagram of a video bitstream unpacker 502 according to an embodiment of the present invention. The input of 502 is the compressed video stream from a client. The input compressed video stream is entropy-decoded by a variable length decoder (VLD) 901 to extract frame and MB header data information, motion vectors, and DCT coefficients. The DCT coefficients from 901 are inverse quantized (Q₁^{31 1}) by module 902. The input motion vectors come from output of module 901 and are used to control a DCT-domain motion compensation module (MC-DCT) 903 based on the DCT frame buffer 904 to generate the motion prediction of the current decoding MB data. The outputs of 502 include DCT coefficients reconstructed by adding the outputs from 902 and 903 at a summing unit 905 according to the input MB mode, i.e. intra or inter, from the VLD module 901. The frame and MB header information and the motion vectors extracted from the input video stream by 901. The reconstructed DCT coefficients for the current input MB are also stored in DCT frame buffer 904 for future MB motion compensation. There are four places in which the video unpacker may be different to a standard H.263 video decoder:

1) IDCT is not required in the unpacker architecture;

2) Motion compensation function is performed in a DCT domain;

3) Reference frame buffer are in the DCT domain;

4) The video unpacker outputs data including the reconstructed DCT coefficients, the frame and MB header information and the motion vector data.

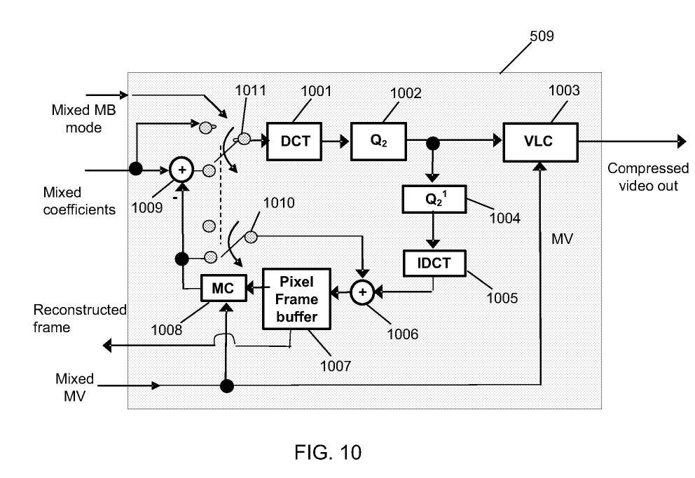

FIG. 10 details an exemplary block diagram of a video bitstream packer 509 according to the present invention. The inputs of 509 include the pre-determined coding mode of adjoining MBs of the current MB in mixed and downscaled frame from mixed MB coding mode decision module 507, the pre-determined mixed-MV value from 508, and the pre-determined mixed coefficients from 506. The outputs of 509 include the compressed mixed stream. The mixed coefficients from 506 are first input into 1009, the reconstructed frame data. There are a number of functional parts within the body of 509. The pre-determined mixed-MB mode is first used by a switch 1011 to determine whether the pre-determined mixed coefficient is directly encoded or predicted before the actual encoding process. If the coding mode of the current MB in the mixed-and-downscaled frame is determined as the INTRA coding mode, the mixed coefficients is directly DCT transformed in 1001, then quantized (Q₂) in 1002, and finally entropy encoded in 1003 by a variable length encoder (VLC). Meanwhile, the output from 1002 is inverse quantized (Q₂⁻¹) in 1004, converted by an inverse DCT 1005, and stored into a pixel frame buffer 1007 which is used by the motion compensation (MC) 1008. On the other hand, if the INTER mode is pre-determined mixed-MB mode; the mixed coefficients need to be subtracted by the predicted MB data from 1008 in 1009 according to the pre-determined mixed-MV value. Then, the predicted error is processed through 1011, 1001, 1002, and 1003 to output into the compressed mixed stream. Meanwhile, the output from 1002 is inverse quantized and inverse “DCT”ed by 1004 and 1005, respectively, before summing pixel frame with the motion compensated data coming through 1010 from 1008 and becoming the reconstructed frame data. The frame data is saved into 1007 to be used for future motion compensation, and output to 508 to facilitate the adaptive motion refinement process. Moreover, advanced bit-rate control mechanism may also be employed by 509 to generate a video stream which satisfies the receiving bandwidth of conference attendees, or a network or network operator desired/required bandwidth.

There are four areas which make the video packer distinct from a standard H.263 video encoder:

1) No on-the-fly MB coding mode decision is performed in the video packer;

2) No on-the-fly motion estimation is conducted in the video packer;

3) The inputs of the packer include not only the mixed coefficients in an appropriate format, but also the pre-determined mixed-MB mode, and mixed-MV data;

4) The primary output of the video packer is the mixed video bitstream, however it also outputs the reconstructed frame data to the AMVRR module.

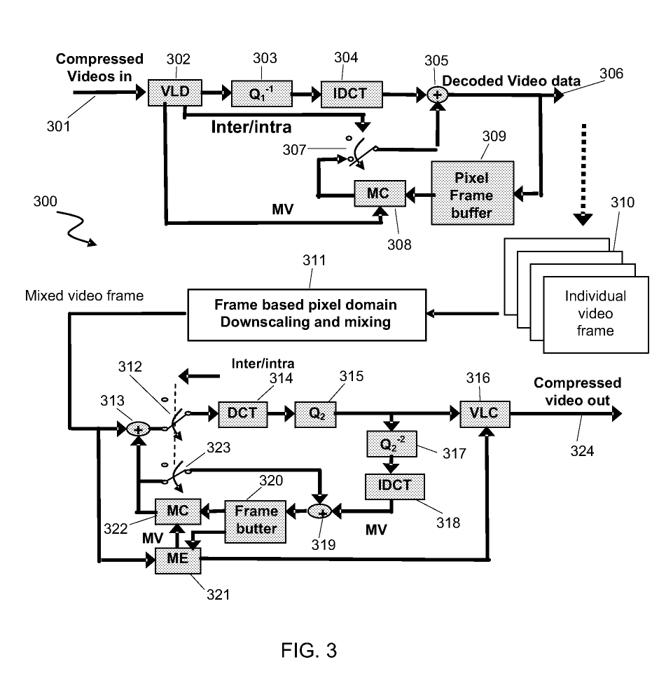

The packer could include other function units as the standard H.263 encoder (FIG. 3), which are DCT (DCT), quantization (Q₂), variable length encoder (VLC), and pixel-domain motion compensation (MC) and frame buffer. Moreover, an advanced bit-rate control mechanism may also be included in the packer to generate a video stream which meets any receiving bandwidth requirements.

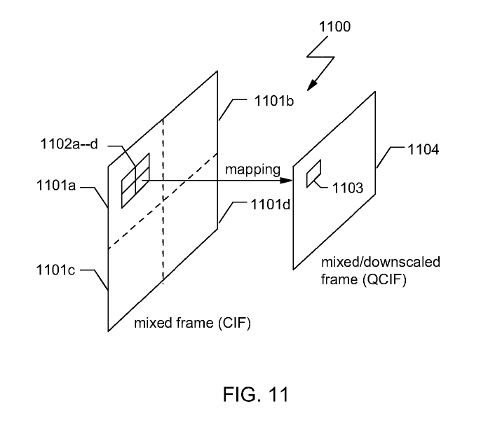

FIG. 11 shows an example of a mixing and downscaling operation to covert four input macro-blocks into one macro-block in the output frame according to a preferred embodiment of the present invention. A primary difference between prior art solutions and the exemplary 1100 is the basic operation data unit. Prior art solutions scale the mixed frame on the pixel level, CIF video frame into a QCIF frame, using a conventional bilinear interpolation algorithm. Four adjoined pixels are grouped and mapped to one pixel in the downscaled frame using the conventional bilinear interpolation algorithm, and the mapped frame is fed into a full video encoder to generate output bitstream. The exemplary 1100 of present invention scales the video data on the MB level. A group of four MB 1102a-d from the input video streams are mixed and downscaled to generate the mixed MB 1103 in the output video frame 1104. The mapping operation includes the prediction of the mixed MB mode from the four decoded MBs, the re-sampling of four MVs to one mixed MV, and the downscaling of the coefficient blocks.

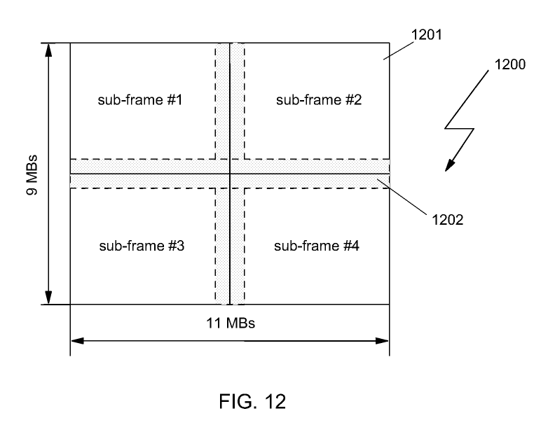

FIG. 12 illustrates a specific exemplary layout 1200 for a mixed frame in QCIF resolution according to a preferred embodiment of the present invention. Each sub-frame 1201 (from sub-frame #1-4) is downscaled from a corresponding input video frame and displayed in the mixed frame according to a pre-determined display layout. Due to the fact that a QCIF frame 1200 only has 9 MB lines, and each MB line consists of 11 MB, there are some MBs in a QCIF frame which have to cross middle lines in horizontal or vertical and these MBs are in the boundaries 1202 of the downscaled sub-frames in the mixed frame. We call these MBs as cross-boundary MBs. Prior-art solutions are pixel based approaches and they can handle this circumstance. The present invention is based on the macro-block level and cannot directly handle this circumstance and instead uses a special mechanism formulated to generate encoding parameters for the cross-boundary-MB 1202 without introducing significant compression overhead to the output stream. A simple mechanism to handle the cross-boundary MBs is to preset boundary MBs to be coded in inter mode with a zero motion vector directly without introducing any mapping process for coding mode and motion vector.

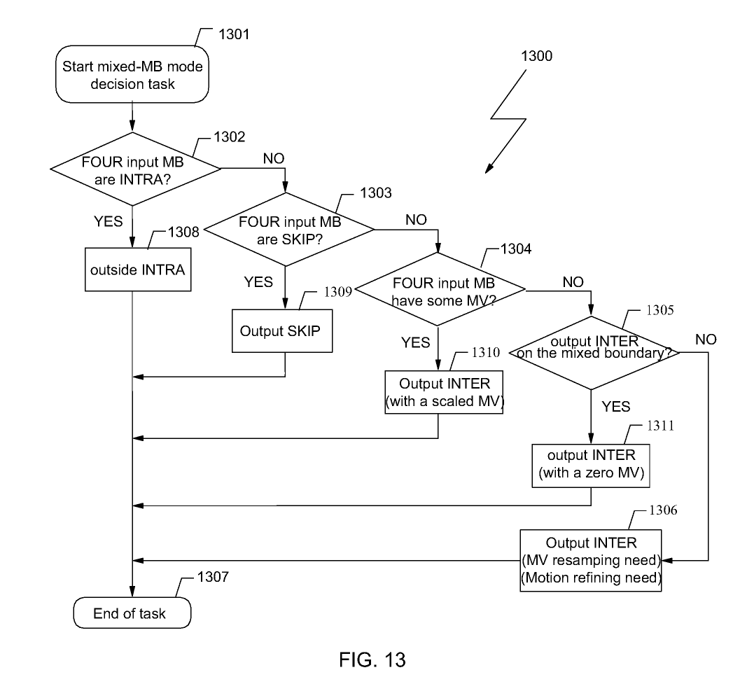

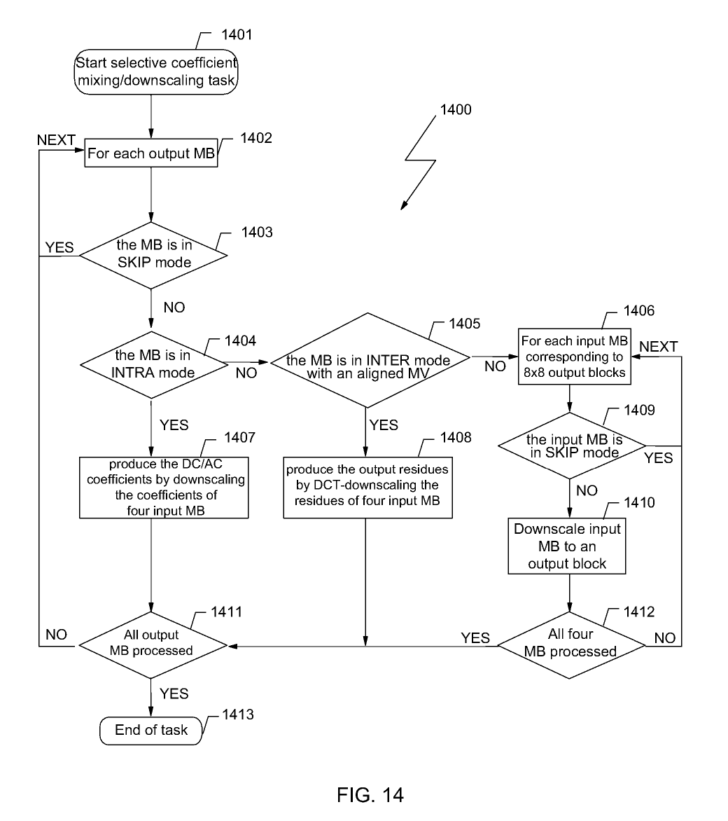

FIG. 13 details an exemplary flowchart 1300 for the mixed MB coding mode decision task process according to the preferred embodiment of the present invention. It illustrates how mixed MB parameters are predicted for the exemplary mixed layout 1200 in accordance with the embodiment of MB based mapping 1100, which is used to generate the parameters (encoding mode and motion vector) for the output MB 1103 according to the parameters of four input MBs 1102a-d and their location on the “virtual” mixed frame 110a-d.

The flowchart starts at 1301 where the encoding modes of four input MB corresponding to an output mixed-MB are provided. Upon receiving a command to start the express prediction task, the encoding modes of all four input MBs are checked first by step 1302 to find whether the all four input MB are in INTRA mode. If all the four MB are encoded using INTRA mode, the output from 1302 is TRUE, and the output mixed MB is determined to be in INTRA mode in the process of ‘output INTRA’ 1308, and no motion vector prediction is required for the mixed MB. The prediction task is finished for the current mixed MB in step 1307.

If all input MB are not encoded by INTRA mode, they are passed to a further checking step 1303 to check whether all the input MBs are encoded in the SKIP mode (SKIP mode means that COD=1 and no motion vector and DCT residues exist in H.263 bit streams), skip may also mean not coded. If the output from 1303 is TRUE, then the mixed MB is determined to be in SKIP mode in step 1309 and then the prediction task is finished for the current output MB.

However, if all four input MBs are neither INTRA nor SKIP and they do not meet the conditions of steps 1302 and 1303, they are further checked at the step 1304 to find if there exists an aligned motion vector (herein the term “aligned” means all the motion vector have same magnitude and direction). If so, the output MB is decided to be in an INTER mode in 1310, and the encoding motion vector is directly scaled from the input motion vector by dividing by two. No further motion re-sampling/refinement is needed for this MB, so the prediction task ends at step 1307.

For those input MB whose mixed counterpart is located across the boundaries of sub-frames, they are directly passed to step 1311 where the corresponding mixed-MB is determined to be in INTER mode with zero motion vector and the prediction task for the current mixed-MB ends.

A special mechanism is included in the step 1305 for the exemplary mixed layout 1200. The output MB located on the boundaries of sub-frames 1202 (the gray area of the output frame 1200) is directly passed to step 1311, where it is mapped to be in INTER mode and with a zero motion vector. This is based on the fact that the boundaries of many “head-and-shoulder” video frames usually have an object sitting in the middle of the frames and nearly frozen background. There is little motion updated near frame boundary area between frames. Setting the output MB as an inter-MB enables the encoder at the later stage to save extra bits on these areas. The prediction task for the current output MB ends after step 1310.

Those remaining input MBs, which cannot satisfy the conditions of steps 1302, 1303, 1304, and 1305, are passed into step 1306, where their mixed MB is decided to be INTER mode. The mixed-MB mode is used in the next stage in selective coefficient mixing/downscaling module 506 (FIG. 5) and adaptive MV re-sampling/refinement 508 module (FIG. 5) to generate accurate motion data for the output stream.

FIG. 14 depicts an exemplary flowchart for the selective coefficient mixing and downscaling task 1400 according to the preferred embodiment of the present invention. The task starts from step 1401 where the mixed MB mode, and the DCT coefficients of corresponding four input MBs are provided. The task processes all four input MBs header information and coefficients associated with each output mixed MB at step 1402. The mixed MB is checked at step 1403 to find out whether it is in SKIP mode. If the output of step 1403 is true, all the coefficient mixing and downscaling process for the mixed MB can be bypassed. If it is not true, the output mixed MB is checked as to whether it is in INTRA mode or not at step 1404. If an INTRA mode is assigned to the output mixed MB, then the coefficients of all four input MBs are downscaled in step 1407 to form the mixed coefficients (the way to process coefficient downscaling can use different algorithms. It can be a fast DCT downscaling method directly performed in the DCT compression domain. It can also be a spatial bilinear algorithm. The selection depends on the type of the input coefficient available at step 1407).

At step 1405, a special type of INTER MB is checked, which is produced by a group of four input MB mixed together with an aligned motion vector. If it is found that the mixed-MB is in INTER mode and is downscaled from four input MBs with an aligned motion vector, the output mixed coefficients (motion residues) are downscaled in the DCT domain at step 1408 directly from the block based motion residues of four input MB, and no motion estimation is further required for such an output mixed MB.

For all the remaining output mixed MB, the mixed coefficients are generated by mixing and downscaling for each of four input MBs mixed together at step 1406. Those input MB encoded in SKIP mode are bypassed again at step 1409 without any updating. Only the INTRA or INTER input MBs are downscaled to the corresponding blocks to constitute the mixed coefficient at step 1410. Such a block based updating routine continues until all four input MBs 1102a-d (FIG. 11) are processed. Then the task shifts back to MB based downscaling at step 1411. If at step 1411 it is found that not all output MBs are processed, the process moves to next group of inputs back to step 1402. Otherwise, the entire task is completed at step 1413.

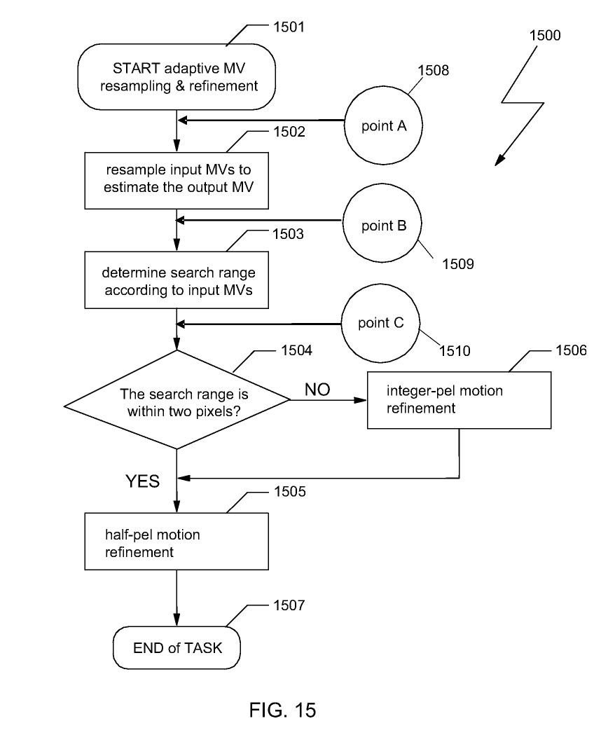

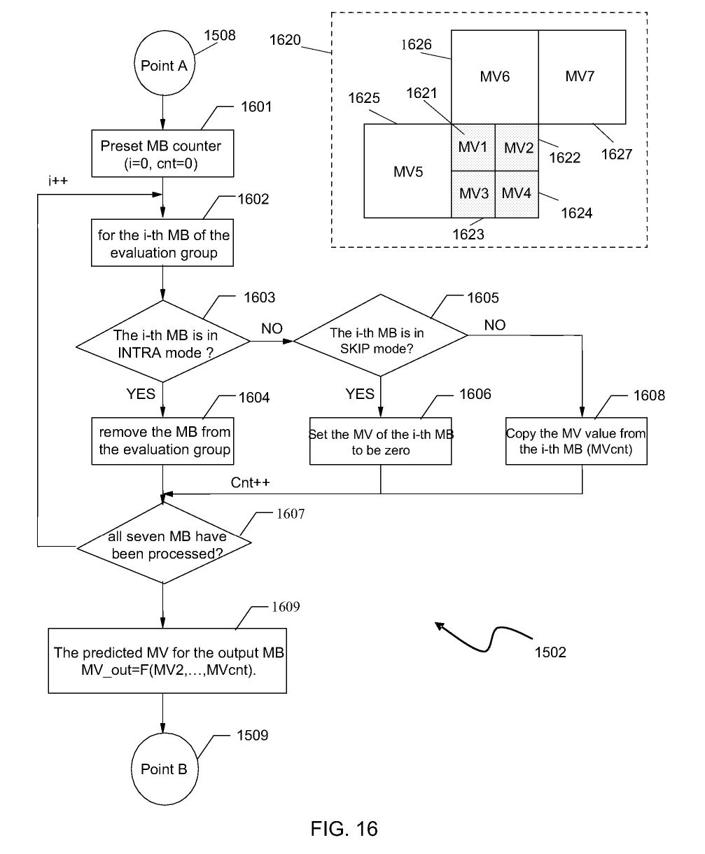

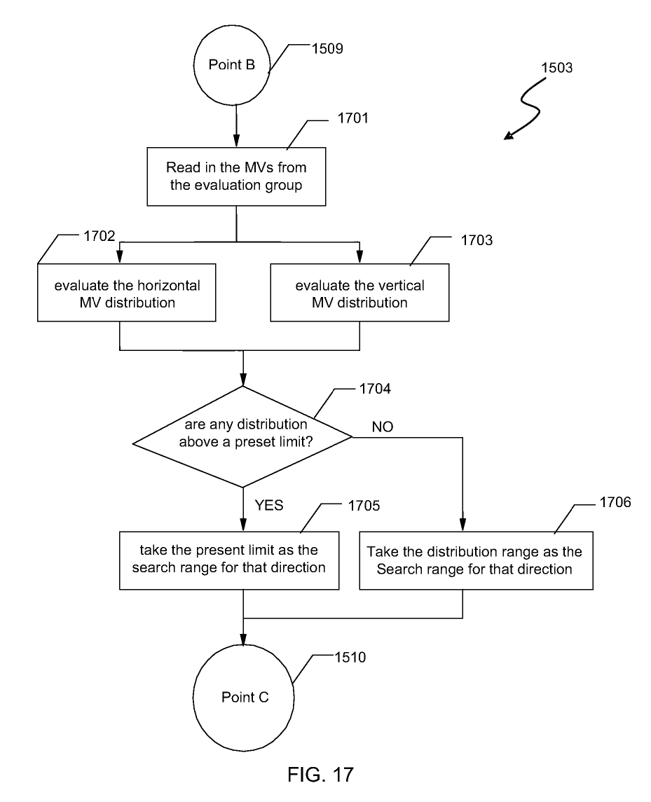

FIG. 15 is a flowchart according to the preferred embodiment of the present invention illustrating the adaptive motion vector re-sampling and refinement process 1500 for outputting an inter MB mapped from a group of input MBs with unaligned motion vectors. The task starts from step 1501. The output mixed motion vector MV value is predicted at step 1502 according to the motion vector of four input MBs and the pre-generated MV for the adjoining neighborhood of current output mixed MB. The motion vector re-sampling routine is described in conjunction with FIG. 16.

Following the prediction of the output motion vector(s) from a group of unaligned input motion vectors is the step of the configuration for motion refinement. At step 1503 the search range for the motion refinement is determined using an adaptive weighted operation according to the distribution of the four input motion vectors. The details of the searching range determination are described in conjunction with FIG. 17.

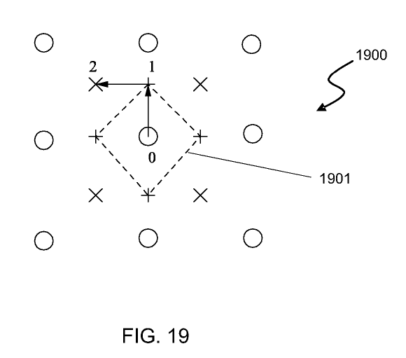

Then the determined search range is evaluated at step 1504. If the range is within [−1, +1] pixel around the predicted motion vector, a half-pel motion refinement is activated at step 1505 to find the optimal motion vector which results in minimum motion residue for the output mixed MB . An exemplary illustration of the half-pel motion refinement 1900 is provided in FIG. 19.

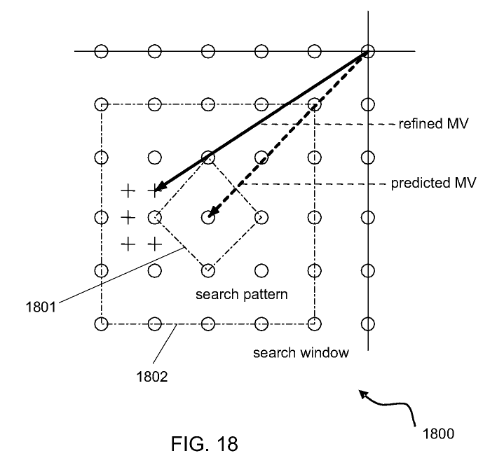

However, if the determined search is above the range of [−1, +1] pixel, an integer-pel motion refinement at step 1506 is activated accordingly. The step of integer-pel motion refinement searches for an optimal mixed MV around the predicted mixed MV obtained from step 1502, within a determined area controlled by the search range output of step 1503. The optimal integer motion vector from step 1506 is further fed into step 1505 to find the best fractal part of the output mixed MV vector. Details of the integer motion refinement 1800 are described in conjunction with FIG. 18. The entire task ends at step 1507 after the motion refinement process is completed, and the MV value generated by the motion refinement is directly used as the mixed MV for the current mixed MB.

FIG. 16 provides a flowchart for the motion vector re-sampling routine at step 1502 of FIG. 15. An example set of the MVs that may be used for the re-sampling routine are illustrated in the block 1620 according to their spatial coordinates, where MV1-4 1621˜1624 corresponding to four input MVs from which the current mixed MV is generated. MV5-7 1625˜1627 represent motion vectors MV of previously generated output mixed MBs which adjoin the current being mixed MB at the left, the top, and the top-right direction. The filled block represent the currently being mixed MB, where the motion vector MV1-4 denote motion vectors of four input MBs from which the output MB is downscaled. These seven MVs are the inputs for the process 1502 and are named as “the evaluation group” herein.

The method of the motion vector re-sampling routine starts from step 1601, where the MB counter (i) and the valid motion vector counter (cnt) are reset to zero. Then at step 1602, the encoding mode of each MB associated with MV 1-7 are checked in multiple steps as follows:

1) If the MB associated with MVi is found to be in INTRA mode at step 1603, then MVi is removed from the evaluation group at step 1604. The motion vector data is not saved;

2) Else if the MB associated with MVi is found to be in SKIP mode at step 1605, then set MVi to be zero motion vector and cnt=cnt+1 at step 1606;

3) Otherwise, keep the value of MVi intact and increase the cnt by one at step 1608.

Following above, step 1607 checks whether all the seven MBs in the evaluation group are processed. If all are not yet processed, return to step 1602 for next MB in the seven MBs. If all seven MBs are processed, a group of (cnt+1) MV candidates are ready for the motion re-sampling filtering step 1609. The MV for the current output mixed MB is calculated (or re-sampled) using a nonlinear filter based on the selected MV candidates. An exemplary nonlinear function is the median of the {MV1, MV2, . . . , MVcnt}. Another nonlinear function could be a median filter. Other filter functions may be utilized herein as well, which could include a weighted average, a weighted median or other statistics filters. The output of step 1609 is the predicted mixed MV which is fed to step 1503 in FIG. 15.

FIG. 17 shows a method of adaptively determining the search range of the motion refinement 1503 according to the valid MVs from the evaluation group shown in 1620 (FIG. 16). The process starts at step 1701 where all the MVs from the evaluation group are supplied. The distribution of the MVs in the horizontal and vertical direction are calculated in steps 1702 and 1703, respectively and the resulted distribution ranges are compared with range limitation, possibly preset, in step 1704 to provide a tradeoff between computation cost and performance. If the MV distribution at either direction is bigger than [−3, +3] pixels, then it is clipped within the preset [−3, +3] range in step 1706 and output to 1510 as the recommended search range for the motion refinement; otherwise the obtained MV distribution is treated as the searching range in 1510.

FIG. 18 illustrates an exemplary implementation 1800 of the adaptive motion refinement 1506˜1505 according to the preferred embodiment of the present invention, where the “predicted MV” is in regards to the mixed MV predicted by the step 1502 in FIG. 15, and the “refined MV” is the mixed MV optimized by the adaptive motion refinement process 1506 and 1505 in FIG. 15 which include an integer-pel motion search routine (indicated by the round mark) according to an adaptive range using fast search pattern, and a fast half-pel motion refinement routine (indicated by the cross mark). The adaptive “search window”, which is a rectangular area surrounding the predicted MV for searching of the refined MV or optimal MV, and is determined by step 1503 depending on the distribution range of input MV values. The width and height of the window are equal to the search range in either direction in FIG. 17. In the exemplary implementation, a diamond pattern is used to speed up the motion searching preserving matching accuracy. Other searching patterns may be used for fast searching, such as spiral pathway, or hexagon shape.

FIG. 19 illustrates an example of half-pel motion refinement 1900 used by 1505 of the present invention. The refinement starts from the integer MV obtained from step 1506, i.e., position 0, and searches around the eight half-pel positions around the position 0. A diamond pattern is also used as a preferred search pattern for the half-pel searching to reduce the computation cost. However, conventional full search method may used as well. The search starts from position 0, goes to position 1 if position 1 is the local minimum position so far, and finally stops at position 2 if a local minimum position is allocated herein. The output of 1505 is the optimal mixed MV in an accuracy of half-pel.

The preferred embodiment of the invention video mixing system can handle a fast update request very efficiently. As the fast update request arrives, the system will preset the next scaled frame as intra frame (through the means of preset the mixed frame type as intra, and all the encoding mode of the mixed MB as intra. In such case, the motion data from the input streams are skipped, and the DCT coefficients for the output intra mixed MB is directly downscaled in the DCT-domain from the DCT frame buffers.

The preferred embodiment of the invention can also handle different frame rates, or differing frame arrival rates for multiple video inputs. One of efficient approaches to handle different frame rate is to keep the output mixed frame rate same as the one which has highest frame rate among all the input frame rates (i.e., 30 fps for the given example). Firstly, the video data from each input stream are unwrapped independently. Then at the time of encoding a new mixed frame, the data associated with each input are sampled from the latest DCT frame buffer. If the data corresponding to a particular input does not updated since the latest encoding time (i.e., for the data with 15 fps and 10 fps input frame rate), all the mixed MBs generated using this input data will be encoded in SKIP mode. As a result, the mixed video will always update according to the highest frame rate.

As the video mixing system mixes multiple video input each participant and sends the mixed video of other participants (without self view) to each participant, part of mixed video information for each output can be re-used during mixing processes for each output. For an example, in a video conference with A, B, C, D, E participants, the output of B could display mixing of A, C, D, E, and the output of C could display mixing of A, B, D, E. and etc. A downscaled picture A′ information appears in different output mixed pictures, possibly in different locations in different layouts.

The preferred embodiment of the invention can also re-use downscaled information at intermediate processing stages. The re-used information could be intermediate parameters, such as mixed motion vectors in each MB, DCT coefficient in each MB, and etc. A good way to enable re-using downscaled information is to conduct motion data mixing and coefficient downscaling independently for input stream. The intermediate data associated with each input is stored in a buffer to facilitate the reused information for further mixed stream generation where the input stream is located in a different sport.

In an application of QCIF resolution video mixing system, the QCIF size is 11×9 MBs where the line of MBs is odd number. The mixing and downscaling process for each input QCIF stream could skip the first line of MBs, mix and downscale the rest MBs according to 4:1 ratio. The resulting intermediate data associated with each input can also be stored in a buffer to facilitate the reused information for further mixed stream generation where the input stream is located in a different spot.

The preferred embodiment of the present invention can perform rate control in the mixing system for output mixed video streams. Rate control mechanisms are performed in packer modules of the mixing system. For an example, a rate control mechanism from H.263 encoder can be applied to a packer outputting H.263 standard video stream.

In further, the rate information of multiple inputs in a video mixing system can be used to get better rate control of output mixed video stream. The intermediate parameters and side information from each input stream, and pre-encoding video data statistics can be combined together to predict the encoding complexity of current mixed frame. The prediction could be used to control the output bit rate.

The preferred embodiment of the present invention can be used in video conferencing applications of multiple video inputs with different frame size. These different input frame sizes could be cropped or stuffed/padded before downscale computation or could use different downscale ratios for each input. Each output mixed video streams could have different frame sizes. Cropping, stuffing or different ratio downscaling can be applied to the output mixed frame before a packer in the video mixing system. The mixed motion vectors, mixed MB mode, mixed coefficients associated with the specific inputs and outputs are processed in cropping, stuffing or different ratio downscaling ways accordingly.

The preferred embodiment of the present invention can be applied in video conferencing applications of multiple video inputs with different video coding methods depending on the application. These video inputs and outputs may have some difference in their video compression, either options/features or standards used. For example, the transform coefficient in H.261 and H.263 video codec is called DCT coefficient, and the transform coefficient in H.264 video codec is called ICT coefficient. The DCT coefficients and DCT coefficient buffer labeled inside the preferred embodiment are generic transform coefficient and transform coefficient buffer and are not limited solely to DCT. ICT coefficients and ICT coefficient buffers would be used if the input video stream uses the H.264standard.

The present invention has been explained with reference to specific embodiments. Others embodiments will be evident to those of ordinary skill in the art. It is therefore not intended that the invention be limited, except as indicated by the appended claims.

What is claimed is:

1. An apparatus for use in video mixing of multiple video sources compressed in one or more video codecs, the apparatus comprising:
a bitstream unpacker configured to receive and unpack each of the multiple video sources to provide intermediate video parameters including transform-domain coefficients, frame header information, macroblock header information, and motion vector data;
an intermediate coefficient buffer coupled to the bitstream unpacker and configured to store the transform-domain coefficients;
a decision module coupled to the bitstream unpacker and configured to provide an output macroblock mode based, in part, on the intermediate video parameters;
a transform-domain coefficient downscaling module coupled to the intermediate coefficient buffer and configured to generate transform-domain output coefficients;
a motion vector refinement module coupled to the bitstream unpacker and configured to generate an output motion vector; and
a bitstream packer coupled to the decision module, the transform-domain coefficient downscaling module, and the motion vector refinement module, wherein the bitstream packer is configured to output multiple video output streams in an output frame, wherein the multiple output streams are compressed using the one or more video codecs.

2. The apparatus of claim 1 wherein the bitstream unpacker comprises a separate bitstream unpacker associated with each of the multiple video sources.

3. The apparatus of claim 1 wherein the bitstream packer comprises a separate bitstream packer associated with each of the multiple video output streams.

4. The apparatus of claim 1 wherein the transform-domain coefficients comprise DCT coefficients.

5. The apparatus of claim 1 wherein the bitstream unpacker comprises:
a variable length decoding (VLD) module;
an inverse quantization (IQ) module coupled to the VLD and configured to perform inverse quantization on the transform-domain coefficients;
a transform-domain motion compensation (MC-DCT) module coupled to the VLD and configured to perform motion compensation in the transform-domain;
a transform-domain frame buffer coupled to the MC-DCT and configured to store a reference frame reconstructed by the MC-DCT module; and
a summing unit coupled between the IQ and the transform-domain frame buffer and configured to generate transform-domain coefficients.

6. The apparatus of claim 1 wherein the decision module comprises:
an analysis module configured to perform analysis of input macroblock modes, the motion vector data, and locations of the multiple video output streams in the output frame; and
a second decision module coupled to the analysis module and configured to determine the output macroblock mode based, in part, on results provided by the analysis module and output a switch signal.

7. The apparatus of claim 1 wherein the transform-domain coefficient downscaling module comprises:
an indexation module configured to generate an output macroblock index for each of one or more macroblocks associated with one of the multiple video sources as a function of a location of the multiple video output streams in the output frame; and
a downscaling module configured to receive transform-domain coefficients from the intermediate coefficient buffer and generate output frame pixel values.

8. The apparatus of claim 7 wherein the downscaling module generates output frame pixel values as a function of an output macroblock index, the one or more macroblocks, the motion vector data and the switch signal.

9. The apparatus of claim 1 wherein the motion vector refinement module further comprises an adaptive motion vector re-sampling and refinement (AMVRR) module.

10. The apparatus of claim 9 wherein the AMVRR comprises:
a motion vector re-sampling module configured to predict one or more predicted motion vectors using an adaptive filtering process;
a second motion vector refinement module configured to tune the one or more predicted motion vectors to produce an output motion vector; and
a motion vector buffer coupled to the motion vector re-sampling module in a feedback loop and configured to store the output motion vector.

11. The apparatus of claim 10 wherein the second motion vector refinement module is configured to reduce a difference between a frame produced by the transform-domain coefficient downscaling module and the output frame.

12. The apparatus of claim 1 wherein the bitstream packer comprises:
a transform-domain module configured to transform the transform-domain coefficients into multiple video output streams;
a quantization module coupled to the transform-domain module;
a variable length coding (VLC) module coupled to the quantization module;
an inverse quantization module coupled to the quantization module;
an IDCT module coupled to the inverse quantization module;
a summing unit coupled to the IDCT module;
a pixel-domain frame buffer coupled to the summing unit and configured to store a reconstructed video frame;
a motion compensation (MC) module coupled to the pixel-domain frame buffer and configured to perform motion compensation based on the output motion vector and the reconstructed video frame; and
a summing unit coupled to the MC module.

13. The apparatus of claim 1 wherein the multiple video sources comprise four or more video sources.

14. The apparatus of claim 1 wherein the multiple video sources comprise two or three video sources.

15. The apparatus of claim 1 wherein the output frame is characterized by a QCIF size.

16. The apparatus of claim 1 wherein the output frame is characterized by a CIF size.

17. A method of mixing video bitstreams from a plurality of sources coupled through a communication system, the method comprising:
receiving a first video stream from a first source;
receiving a second video stream from a second source;
unpacking the first video stream to provide a first set of macroblock coding modes, first motion vector data, and first transform coefficients;
unpacking the second video stream to provide a second set of macroblock coding modes, second motion vector data, and second transform coefficients;
predicting an encoding mode for a first output macroblock based, in part, on the first set of macroblock coding modes;
downscaling the first transform coefficients to provide first output transform coefficients;
constructing the first output macroblock using the first output transform coefficients;
downscaling the second transform coefficients to provide second output transform coefficients;
constructing the second output macroblock using the second output transform coefficients; and
constructing an output video stream having an output video frame including the first output macroblock disposed in a first portion of the output video frame and the second output macroblock disposed in a second portion of the output video frame.

18. The method of claim 17 wherein constructing the second output macroblock is performed prior to constructing a final output macroblock disposed in the first portion of the output video frame, wherein constructing the final output macroblock represents a termination of an encoding process for the first potion of the output video frame.

19. The method of claim 17 wherein predicting an encoding mode for an output macroblock is based, in part, on the first motion vector data.

20. The method of claim 17 wherein the first video stream and the second video stream are characterized by a same frame size and the output video frame is characterized by the same frame size.

21. The method of claim 20 wherein the same frame size is QCIF.

22. The method of claim 17 wherein the plurality of sources comprises video streams encoded using different video compression standards and the output video stream is encoded using a single video compression standard.

23. The method of claim 17 further comprising constructing a second output video stream having a second output video frame including the first output macroblock disposed in an another first portion of the video frame and the second output macroblock disposed in a second portion of the video frame.

24. The method of claim 17 further comprising constructing one or more additional output video streams.

25. The method of claim 24 wherein a number of output video streams is equal to a number of the plurality of sources and wherein the output video stream comprises the output video stream and the one or more additional output video streams.

26. The method of claim 24 wherein at least one of the one or more additional output video streams and the output video stream comprise different video standards.

27. The method of claim 17 further comprising determining an output macroblock coding mode as a function of the first set of macroblock coding modes.

28. The method of claim 17 further comprising determining a set of output macroblock coding modes as a function of the first set of macroblock coding modes, the second set of macroblock coding modes, and an INTER macroblock associated with each of the plurality of sources.

29. The method of claim 17 wherein the first output transform coefficients and the second output transform coefficients are provided as functions of the first set of macroblock coding modes, the second set of macroblock coding modes, the first motion vector data, and the second motion vector data.

30. The method of claim 17 further comprising re-sampling an output motion vector as a function of the first motion vector data.

31. The method of claim 30 further comprising refining the output motion vector using a predetermined refinement range.

32. The method of claim 17 wherein the plurality of sources comprises five video images associated with five users and the output video frame provided to each of the five users comprises video images associated with each of the other four users displayed in four quadrants of the output video frame.

33. The method of claim 17 wherein the first video stream, the second video stream, and the output video stream are characterized by a QCIF frame size.
